(19) United States
(12) Patent Application Publication
(10) Pub. No.: US 2024/0169580 A1
(43) Pub. Date: May 23, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventor: MASASHI ESHIMA, TOKYO (JP)

(21) Appl. No.: 18/549,407

(22) PCT Filed: Jan. 19, 2022
(86) PCT No.: PCT/JP2022/001799

§ 371 Date: Sep. 7, 2023

(30) Foreign Application Priority Data
Mar. 22, 2021 (JP) 2021-047367

(51) Int. Cl. G06T 7/70; G06T 7/246; G06T 17/05; G06V 10/141; G06V 10/25; G06V 10/44

(52) U.S. Cl. CPC G06T 7/70; G06T 7/246; G06T 17/05; G06V 10/141; G06V 10/25; G06V 10/44

(57) ABSTRACT

The present technology relates to an information processing device, an information processing method, and a program that can achieve power saving without compromising the accuracy of Visual SLAM.

The information processing device performs, on the basis of sensing information acquired by a sensor, which includes an image sensor, and including image information acquired by the image sensor, self-position estimation of a moving body having mounted thereon the information processing device and generation of map information including three-dimensional information regarding a feature point, and controls a lighting device used for imaging by the image sensor on the basis of at least one of a state of the moving body and the map information. The present technology is applicable to inspection systems using moving bodies.

### TECHNICAL FIELD

The present technology relates to an information processing device, an information processing method, and a program, in particular, to an information processing device, an information processing method, and a program that can achieve power saving without compromising the accuracy of Visual SLAM (Simultaneous Localization and Mapping).

### BACKGROUND ART

There is an increasing demand for inspecting places that are difficult for people to access, using drones or carts. In particular, in a case of inspecting indoor environments where GPS (Global Positioning System) signals cannot reach, self-localization technologies using cameras (Visual SLAM) are used, for example.

Further, the places to be inspected are often dark or dimly lit places with no lighting device, such as inside tanker tanks, inside containers, or under bridges. Thus, drones or carts themselves require lighting devices for Visual SLAM.

For example, a technology that enables imaging with a camera even in dark places by controlling the lighting device on the basis of the brightness of the surroundings has been disclosed (see PTL 1).

### CITATION LIST

### Patent Literature

[PTL 1]
Japanese Patent Laid-open No. 2019-109854

### SUMMARY

### Technical Problem

However, drones and carts generally operate on batteries. Since lighting devices consume a lot of power, when the lighting devices are kept on all the time in dark places, the battery consumption is fast, resulting in short operating time of the drones and carts.

The present technology has been made in view of such circumstances and can achieve power saving without compromising the accuracy of Visual SLAM.

### Solution to Problem

According to one aspect of the present technology, there is provided an information processing device including a self-position estimation unit configured to perform, on the basis of sensing information acquired by a sensor, which includes an image sensor, and including image information acquired by the image sensor, self-position estimation of a moving body having mounted thereon the information processing device and generation of map information including three-dimensional information regarding a feature point, and a lighting control unit configured to control a lighting device used for imaging by the image sensor on the basis of at least one of a state of the moving body and the map information.

In one aspect of the present technology, on the basis of sensing information acquired by a sensor, which includes an image sensor, and including image information acquired by the image sensor, self-position estimation of a moving body having mounted thereon an information processing device and generation of map information including three-dimensional information regarding a feature point are performed. Then, a lighting device used for imaging by the image sensor is controlled on the basis of at least one of a state of the moving body and the map information.

### BRIEF DESCRIPTION OF DRAWINGS

FIG. 1 is a diagram illustrating an overview of an inspection system of a first embodiment to which the present technology is applied.

FIG. 2 is a block diagram illustrating a first configuration example of the inspection system of FIG. 1.

FIG. 3 depicts diagrams illustrating exemplary Lookup Tables representing functions that convert a feature point distance and a feature point contrast into scores.

FIG. 4 is a flowchart illustrating the processing of the inspection system of FIG. 2.

FIG. 5 is a block diagram illustrating a second configuration example of the inspection system of FIG. 1.

FIG. 6 is a flowchart illustrating the processing of the inspection system of FIG. 5.

FIG. 7 is a block diagram illustrating a third configuration example of the inspection system of FIG. 1.

FIG. 8 is a diagram illustrating an overview of an inspection system of a second embodiment to which the present technology is applied.

FIG. 9 is a block diagram illustrating a configuration example of the inspection system of FIG. 8.

FIG. 10 is a block diagram illustrating a detailed configuration example of the inspection system of FIG. 8.

FIG. 11 depicts diagrams illustrating exemplary Lookup Tables representing functions that take velocity and angular velocity as inputs and return appropriate frame rates for Visual SLAM.

FIG. 12 is a flowchart illustrating the processing of the inspection system of FIG. 10.

FIG. 13 is a diagram illustrating an overview of an inspection system of a third embodiment to which the present technology is applied.

FIG. 14 is a block diagram illustrating a first configuration example of the inspection system of FIG. 13.

FIG. 15 depicts diagrams illustrating exemplary Lookup Tables representing functions that take velocity and angular velocity as inputs and convert the inputs into corresponding Scores.

FIG. 16 is a flowchart illustrating the processing of the inspection system of FIG. 14.

FIG. 17 is a block diagram illustrating a second configuration example of the inspection system of FIG. 13.

FIG. 18 depicts diagrams illustrating exemplary Lookup Tables representing functions that take velocity and angular velocity as inputs and convert the inputs into corresponding Scores.

FIG. 19 is a flowchart illustrating the processing of the inspection system of FIG. 17.

FIG. 20 is a block diagram illustrating a configuration example of a computer.

### DESCRIPTION OF EMBODIMENTS

Now, modes for carrying out the present technology are described. The description is given in the following order.
1. First Embodiment (Map Information)
2. Second Embodiment (Exposure Timing)
3. Third Embodiment (Movement Velocity)
4. Others

### 1. First Embodiment (Map Information)

### <Overview of Inspection System>

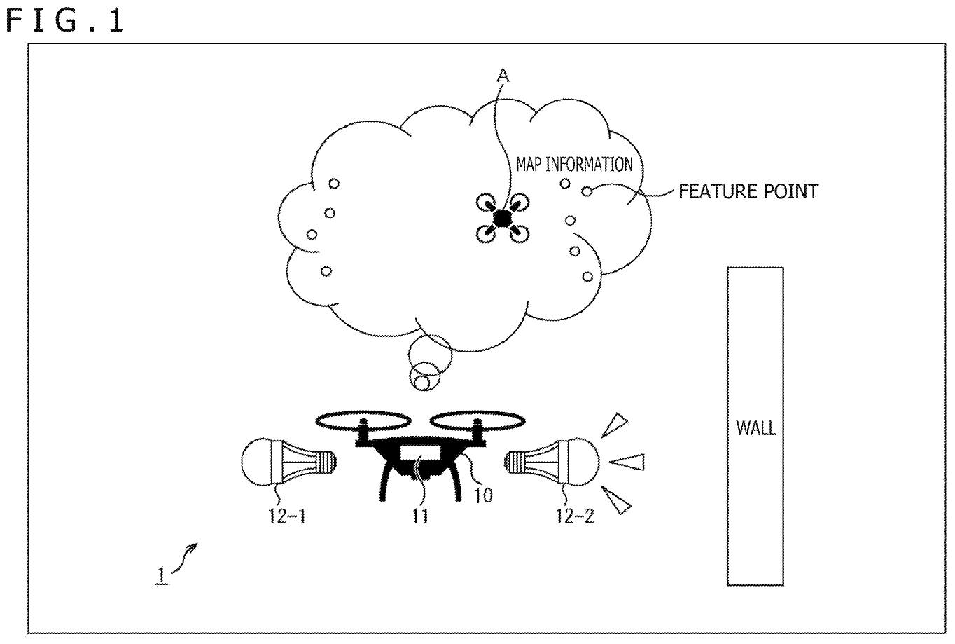

FIG. 1 is a diagram illustrating an overview of an inspection system of a first embodiment to which the present technology is applied.

An inspection system 1 is a system configured to inspect dark places with no lighting device, such as inside tanker tanks, inside containers, or under bridges, using a moving body such as a drone 10. Note that the moving body is not limited to the drone 10 and may be an AGV (Automatic Guided Vehicle) or the like.

The inspection system 1 of FIG. 1 includes the drone 10, an information processing device 11, and lighting devices 12-1 and 12-2. In FIG. 1, the triangles illustrated around the lighting device 12-2 indicate that the lighting device 12-2 is on. This holds also true for the following figures.

The information processing device 11 is mounted on the drone 10. The information processing device 11 performs Visual SLAM, acquires the self-position state of the drone 10, and holds three-dimensional map information regarding places that the drone 10 has passed once. The self-position state of the drone 10 includes self-position, posture, velocity (movement velocity), angular velocity, and the like. The map information includes feature point information that is three-dimensional position information regarding feature points. The information processing device 11 further predicts the near-future self-position state of the drone 10. On the basis of the information indicating the self-position state and the map information, the information processing device 11 determines the direction in which valid feature points for Visual SLAM exist and controls the illumination of the lighting devices.

In the upper part of FIG. 1, an image of map information is illustrated. In the map information, an icon A and a plurality of circles are illustrated. The icon A represents the position of the drone 10, and the plurality of circles represents the positions of respective feature points.

The lighting devices 12-1 and 12-2 are provided at different positions on the housing of the drone 10 to face different directions. For example, when the drone 10 is moving along the right wall inside a large tanker tank as illustrated in FIG. 1, the information processing device 11 turns on the lighting device 12-2 in the direction in which the feature point corresponding to the nearby wall exists (right direction). On the other hand, the information processing device 11 does not turn on the lighting device 12-1 in the direction in which only the distant feature points exist (left direction).

Hereinafter, in a case where there is no particular need to distinguish between the lighting devices 12-1 and 12-2, the lighting devices 12-1 and 12-2 are referred to as a “lighting device 12.”

Note that, in FIG. 1, the lighting devices 12-1 and 12-2 are illustrated, but the number of the lighting devices 12 is not limited to two, and a small number of lighting devices 12, e.g., one or two lighting devices 12 whose facing (illumination) direction can be controlled may be provided. Alternatively, the lighting devices 12 for respective directions may be provided in advance to face the corresponding directions.

From the above, in the inspection system 1, power saving can be achieved without compromising the accuracy of Visual SLAM.

### <First Configuration Example of Inspection System>

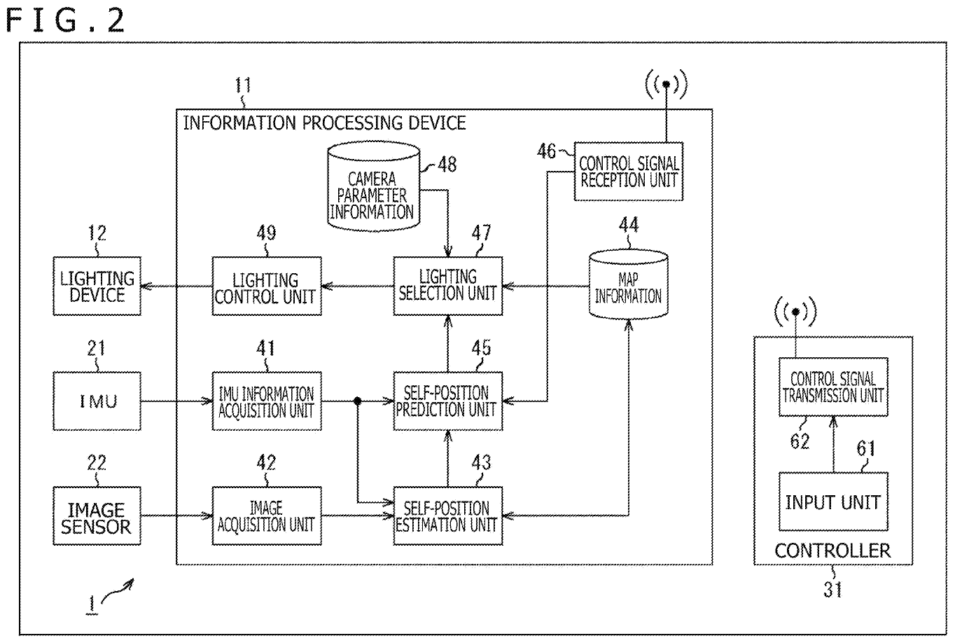

FIG. 2 is a block diagram illustrating a first configuration example of the inspection system 1 of FIG. 1.

In FIG. 2, the inspection system 1 includes the information processing device 11, the lighting device 12, an IMU (inertial measurement unit) 21, an image sensor 22, and a controller 31. In FIG. 2, parts corresponding to those of FIG. 1 are denoted by the same reference signs.

The information processing device 11 includes an IMU information acquisition unit 41, an image acquisition unit 42, a self-position estimation unit 43, a map information storage unit 44, a self-position prediction unit 45, a control signal reception unit 46, a lighting selection unit 47, a camera parameter information storage unit 48, and a lighting control unit 49. Note that, for the sake of convenience in description, parts of the information processing device 11, such as parts related to the drive control of the drone 10, are omitted. The same applies to the subsequent block diagrams.

The IMU information acquisition unit 41 acquires IMU information from the IMU 21 and outputs the acquired IMU information to the self-position estimation unit 43 and the self-position prediction unit 45. The IMU information includes velocity information, angular velocity information, and the like.

The image acquisition unit 42 acquires image information from the image sensor 22 and outputs the acquired image information to the self-position estimation unit 43.

The self-position estimation unit 43 performs Visual SLAM on the basis of the IMU information supplied from the IMU information acquisition unit 41 and the image information supplied from the image acquisition unit 42. That is, the self-position estimation unit 43 performs self-position estimation of the drone 10 and generates map information including three-dimensional feature point information. The self-position estimation unit 43 outputs the generated map information to the map information storage unit 44.

The map information storage unit 44 includes a storage medium such as a memory and stores the map information supplied from the self-position estimation unit 43.

Further, the self-position estimation unit 43 outputs, of the estimated self-position state of the drone 10, the information regarding the self-position and posture to the self-position prediction unit 45. It is anticipated that there is a certain delay in the output of the self-position estimation unit 43.

In order to reduce a delay in the output from the self-position estimation unit 43, the self-position prediction unit 45 predicts the near-future self-position state on the basis of the result of the self-position estimation supplied from the self-position estimation unit 43 and the IMU information supplied from the IMU information acquisition unit 41. At that time, in a case where there is a control signal supplied from the control signal reception unit 46, the control signal is also referred to. The self-position prediction unit 45 outputs information indicating the predicted self-position state to the lighting selection unit 47.

The control signal reception unit 46 receives the control signals transmitted from the controller 31 and outputs the received control signals to the self-position prediction unit 45.

The lighting selection unit 47 determines which direction of the lighting device 12 to turn on using, of the map information stored in the map information storage unit 44 and the information indicating the self-position state supplied from the self-position prediction unit 45, the information regarding the self-position and posture. Note that, at that time, the camera parameter information stored in the camera parameter information storage unit 48 is also referred to. The lighting selection unit 47 outputs the determination result of whether to turn on or off each of the lighting devices 12 to the lighting control unit 49.

The camera parameter information storage unit 48 includes a storage medium such as a memory and stores camera parameter information such as the optical center, the principal point, and the focal length. The lighting selection unit 47 can use these pieces of camera parameter information to grasp where in the image sensor 22 which point corresponding to the feature point information of the map information is projected.

The lighting control unit 49 controls turning-on or turning-off of each of the lighting devices 12 on the basis of the determination result of whether to turn on or off the corresponding lighting device 12 supplied from the lighting selection unit 47.

The IMU 21 includes at least an acceleration sensor, an angular velocity sensor, and the like. The IMU 21 is provided to the housing of the drone 10 and observes the IMU information obtained from the operation of the drone 10.

The image sensor 22 is provided to the housing of the drone 10 and images an object to generate image information. The image sensor 22 outputs the generated image information to the image acquisition unit 42.

The controller 31 includes, for example, a proportional transmitter (transmitter for RC (Radio Control)) or a laptop personal computer. The controller 31 includes an input unit 61 and a control signal transmission unit 62.

The input unit 61 receives information corresponding to the user's operation.

The control signal transmission unit 62 wirelessly transmits control signals based on the information input from the input unit 61 to the information processing device 11.

### <Details of Lighting Selection Processing>

The lighting selection unit 47 acquires information regarding the near-future self-position and posture in the map information supplied from the self-position prediction unit 45. The lighting selection unit 47 determines which direction of the lighting device 12 to turn on, on the basis of the information regarding the near-future self-position and posture and the information regarding the feature points in the map information.

The information regarding feature points includes the number of feature points, the distances to the feature points, position, direction, contrast, ease of tracking feature points, and the like. The ease of tracking feature points is based on information such as whether feature points form repetitive patterns or not, the magnitude of contrast, whether animal bodies exist or not, and the number of successful tracking attempts in the past.

For example, the lighting selection unit 47 calculates a score in Equation (1) below for each direction (for example, front, back, left, right, up, and down) of the drone 10 and determines whether to turn on or off each of the lighting devices 12 with a priority on turning on the lighting device 12 in the direction with the higher score.

[Math. 1]

Score=Σ the number of feature points*f(dₐ)*g(oₙ)*Weight: (1)

where n represents each feature point, dₙ represents the distance from the drone 10 to each feature point, Cₙ represents the magnitude of contrast of each feature point, and Weightₙ represents the weighting coefficient determined on the basis of factors that reduce the score, such as whether each feature point forms a repetitive pattern or whether there are many animal bodies.

f( ) is a function that converts a feature point distance d into a score, and g( ) is a function that converts a feature point contrast c into a score.

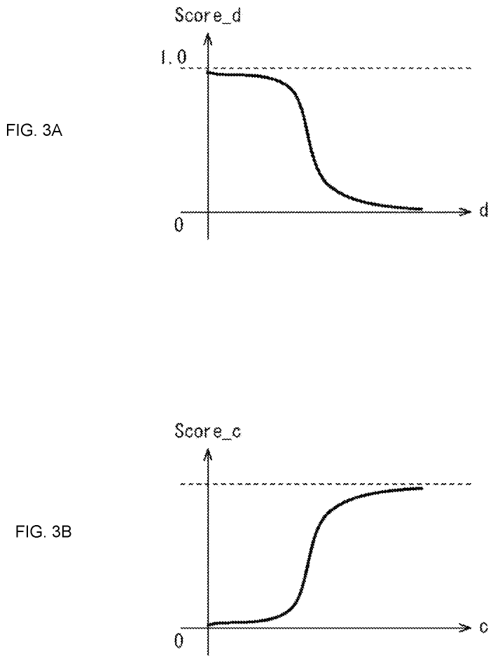

FIG. 3 depicts diagrams illustrating exemplary Lookup Tables representing functions that convert the feature point distance d and the feature point contrast c into scores.

The Lookup Table illustrated in A of FIG. 3 represents f( ) that is a function that converts the feature point distance d into a score Score_d. As illustrated in A of FIG. 3, the larger the feature point distance d, the smaller the score Score_d.

The Lookup Table illustrated in B of FIG. 3 represents g( ) that is a function that converts the feature point contrast c into a score Score_c. As illustrated in B of FIG. 3, the higher the feature point contrast c, the larger the score Score_c.

Note that the lighting intensity of each of the lighting devices 12 may be calculated on the basis of the feature point distance dₙ or the feature point contrast Cn.

For example, in a case where there are many feature points with the small feature point distance d in the direction where each of the lighting devices 12 is facing, the lighting selection unit 47 reduces the lighting intensity of the lighting device. In a case where there are many feature points with the large feature point distance d, the lighting selection unit 47 increases the lighting intensity of the lighting device 12. In a case where there are many feature points with the high feature point contrast c in the direction where each of the lighting devices 12 is facing, the lighting selection unit 47 reduces the lighting intensity of the lighting device. In a case where there are many feature points with the low feature point contrast c, the lighting selection unit 47 reduces the lighting intensity of the lighting device 12.

In this case, the lighting control unit 49 performs lighting intensity settings for each of the lighting devices 12 on the basis of the lighting intensity of the corresponding lighting device 12 supplied from the lighting selection unit 47.

### <Processing of Inspection System>

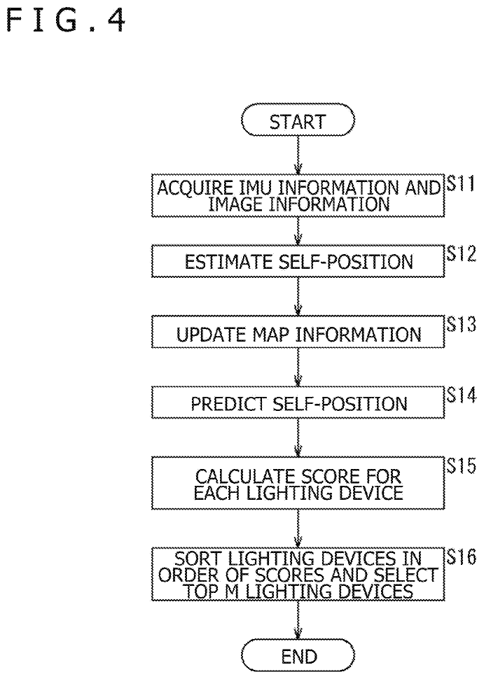

FIG. 4 is a flowchart illustrating the processing of the inspection system 1 of FIG. 2.

In Step S11, the IMU information acquisition unit 41 and the image acquisition unit 42 acquire IMU information and image information, respectively. The IMU information is output to the self-position estimation unit 43 and the self-position prediction unit 45. The image information is output to the self-position estimation unit 43.

In Step S12, the self-position estimation unit 43 performs self-position estimation of the drone 10 on the basis of the IMU information supplied from the IMU information acquisition unit 41 and the image information supplied from the image acquisition unit 42. The result of the self-position estimation is output to the self-position prediction unit 45.

In Step S13, the self-position estimation unit 43 generates map information including three-dimensional feature point information and outputs the map information to the map information storage unit 44. The map information storage unit 44 updates the map information using the map information supplied from the self-position estimation unit 43.

In Step S14, the self-position prediction unit 45 predicts the near-future self-position state on the basis of the result of the self-position estimation supplied from the self-position estimation unit 43 and the IMU information supplied from the IMU information acquisition unit 41.

In Step S15, the lighting selection unit 47 calculates a score for each of the lighting devices 12 using, of the map information stored in the map information storage unit 44 and the information indicating the self-position state supplied from the self-position prediction unit 45, the information indicating the self-position and posture.

In Step S16, the lighting selection unit 47 sorts the lighting devices 12 in order of scores and selects the top M lighting devices 12. M represents the number of lighting devices allowed to be turned on. M may be set in advance or determined from the remaining battery.

After Step S16, the lighting control unit 49 controls turning-on or turning-off of each of the lighting devices 12 on the basis of the determination result of whether to turn on or off the corresponding lighting device 12 supplied from the lighting selection unit 47. That is, the lighting control unit 49 turns on the top M lighting devices 12 selected by the lighting selection unit 47 and turns off the other lighting devices 12.

As described above, in the inspection system 1, the minimum necessary lighting devices 12 for performing Visual SLAM are controlled to be turned on, thereby enabling flight without sacrificing the performance of Visual SLAM and extension of the operating time.

### <Second Configuration Example of Inspection System>

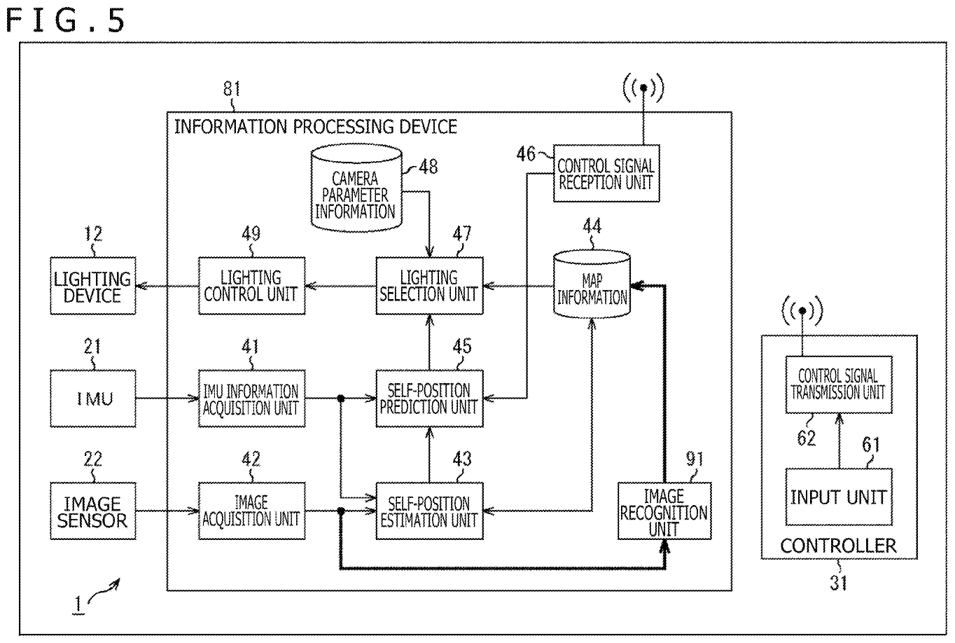

FIG. 5 is a block diagram illustrating a second configuration example of the inspection system 1 of FIG. 1.

The inspection system 1 of FIG. 5 includes an information processing device 81, the lighting device 12, the IMU 21, the image sensor 22, and the controller 31. In FIG. 5, parts corresponding to those of FIG. 2 are denoted by the same reference signs.

In FIG. 5, the information processing device 81 is different from the information processing device 11 of FIG. 2 in that an image recognition unit 91 is added.

That is, the image information supplied from the image acquisition unit 42 is output to the self-position estimation unit 43 and the image recognition unit 91.

The image recognition unit 91 performs image recognition using the image information acquired by the image acquisition unit 42 and detects invalid areas where valid feature points for Visual SLAM are not obtained. The image recognition unit 91 outputs position information regarding the detected invalid areas to the map information storage unit 44.

Invalid areas are, for example, areas dominated by many reflective objects such as mirrors, or areas that can easily change due to the propellers of the drone 10 or the wheels of the cart, such as water, soil, or grass.

The map information storage unit 44 updates the map information on the basis of the position information regarding the invalid areas supplied from the image recognition unit 91.

### <Processing of Inspection System>

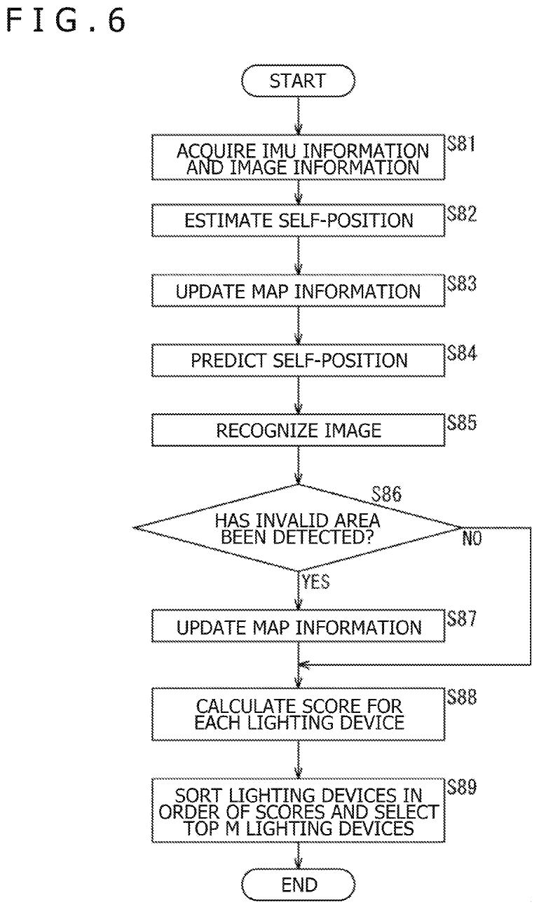

FIG. 6 is a flowchart illustrating the processing of the inspection system 1 of FIG. 5.

Note that the processing in Step S81 to Step S84, Step S88, and Step S89 of FIG. 6 is similar to that in Step S11 to Step S16 of FIG. 4, and hence description thereof is omitted to avoid repetitive description.

In Step S85, the image recognition unit 91 performs image recognition using the image information acquired by the image acquisition unit 42 and recognizes and detects invalid areas.

In Step S86, the image recognition unit 91 determines whether invalid areas have been detected or not. In a case where it is determined in Step S86 that invalid areas have been detected, the processing proceeds to Step S87. At this time, the image recognition unit 91 outputs position information regarding the detected invalid areas to the map information storage unit 44.

In Step S87, the map information storage unit 44 updates the map information on the basis of the position information regarding the invalid areas supplied from the image recognition unit 91. The position information regarding the invalid areas is reflected in the value of Weightₙ, for example, to reduce the score in Equation (1) described above. After Step S87, the processing proceeds to Step S88.

In a case where it is determined in Step S86 that no invalid area has been detected, the processing in Step S87 is skipped, and the processing proceeds to Step S88.

As described above, by using image recognition, the lighting device 12 can be prevented from being turned on in directions where invalid areas where valid feature points for Visual SLAM are not obtained exist. With this, power saving can be achieved without compromising the accuracy of Visual SLAM.

### <Third Configuration Example of Inspection System>

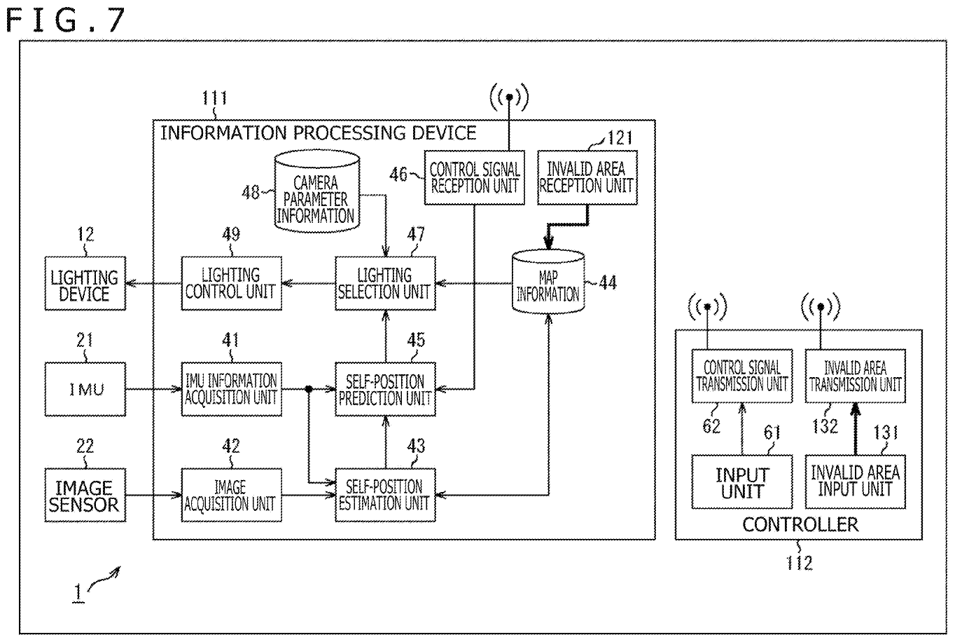

FIG. 7 is a block diagram illustrating a third configuration example of the inspection system 1 of FIG. 1.

The inspection system 1 of FIG. 7 includes an information processing device 111, the lighting device 12, the IMU 21, the image sensor 22, and a controller 112. In FIG. 7, parts corresponding to those of FIG. 2 are denoted by the same reference signs.

In FIG. 7, the information processing device 111 is different from the information processing device 11 of FIG. 2 in that an invalid area reception unit 121 is added.

That is, the invalid area reception unit 121 receives a signal indicating the position of the invalid area transmitted from the controller 112 and outputs position information regarding the invalid area corresponding to the received signal to the map information storage unit 44.

The map information storage unit 44 updates the map information using the position information regarding the invalid area supplied from the invalid area reception unit 121.

The controller 112 is different from that for the information processing device 11 of FIG. 2 in that an invalid area input unit 131 and an invalid area transmission unit 132 are added.

That is, the invalid area input unit 131 inputs position information regarding an invalid area corresponding to the user's operation.

The invalid area transmission unit 132 transmits a signal indicating the position of an invalid area based on the information input from the invalid area input unit 131 to the information processing device 111.

Note that the processing of the inspection system 1 of FIG. 7 is different from the processing of the inspection system 1 of FIG. 5 described above with reference to FIG. 6 only in that image recognition in Step S85 is replaced by invalid area reception, and hence description thereof is omitted.

As described above, invalid areas where valid feature points for Visual SLAM are not obtained can also be specified by the user operating the controller 112.

### 2. Second Embodiment (Exposure Timing)

### <Overview of Inspection System>

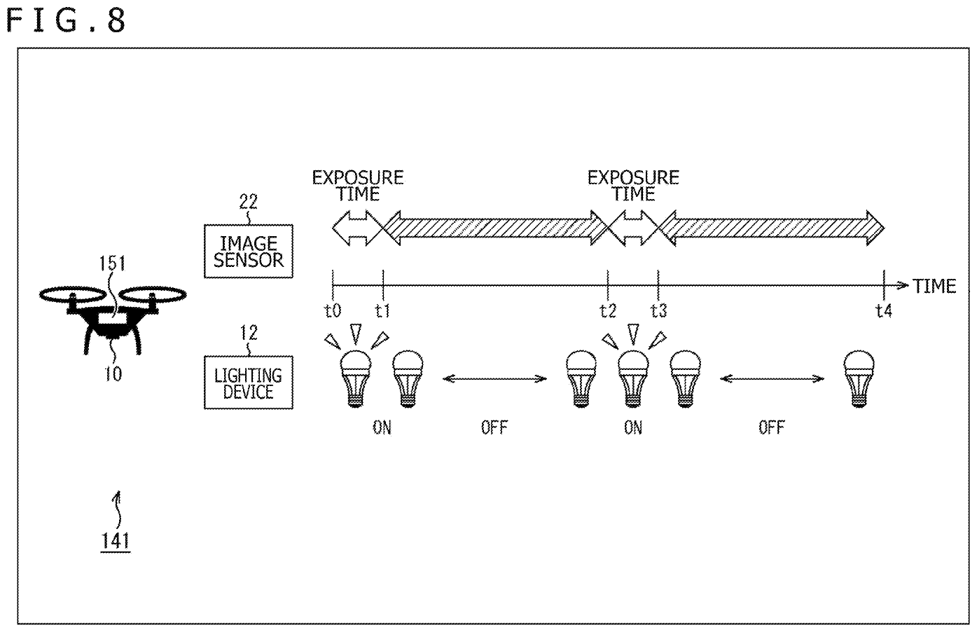

FIG. 8 is a diagram illustrating an overview of an inspection system of a second embodiment to which the present technology is applied.

An inspection system 141 includes the drone 10, an information processing device 151, the lighting device 12, and the image sensor 22. In FIG. 8, parts corresponding to those of FIG. 1 are denoted by the same reference signs.

The inspection system 141 of FIG. 8 is different from the inspection system 1 of FIG. 1 in that the information processing device 11 is replaced by the information processing device 151.

In the inspection system 141, the information processing device 151 performs Visual SLAM and controls the exposure of the image sensor 22 and the on and off of the lighting device 12.

FIG. 8 illustrates the exposure time of the image sensor 22 provided to the housing of the drone 10 and a turn-on timing of the lighting device 12. Note that the period from an exposure start timing to an exposure end timing is the exposure time (exposure period). Further, the interval between the timing of the start of exposure for a certain image and the timing of the start of exposure for the next image is the imaging interval.

The image sensor 22 is not always exposed. In particular, for Visual SLAM, since motion blur affects the result of self-position estimation, the image sensor 22 is typically set to have a short exposure time of from approximately 2 milliseconds to approximately 3 milliseconds. For example, in a case where the frame rate is 30 frames per second, while the image interval is 33 milliseconds, the exposure time is 3 milliseconds, which is approximately 1/11 of the image interval and very short.

Since there is no need to turn on the lighting device 12 during the unexposed time, the information processing device 151 turns on the lighting device 12 only during the exposure time of the image sensor 22, as illustrated in FIG. 8.

The period from a timing t0 to a timing t1 is the exposure time of the image sensor 22, and during that period, the information processing device 151 turns on the lighting device 12. The period from the timing t1 to a timing t2 is the time when the image sensor 22 is not exposed, and during that period, the information processing device 151 turns off the lighting device 12.

The period from the timing t2 to a timing t3 is the exposure time of the image sensor 22, and during that period, the information processing device 151 turns on the lighting device 12. The period from the timing t3 to a timing t4 is the time when the image sensor 22 is not exposed, and during that period, the information processing device 151 turns off the lighting device 12.

Thus, in the inspection system 141, power saving can be achieved by controlling the illumination of the lighting device 12 on the basis of the exposure time (exposure timing) of the image sensor 22.

### <Configuration of Inspection System>

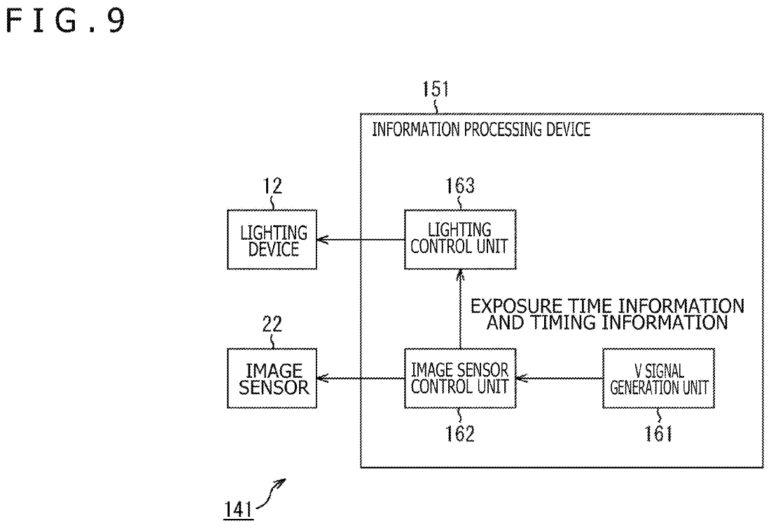

FIG. 9 is a block diagram illustrating a configuration example of the inspection system 141 of FIG. 8.

In FIG. 9, the inspection system 141 includes the information processing device 151, the lighting device 12, and the image sensor 22, as described above with reference to FIG. 8. Note that FIG. 9 illustrates only portions of the configuration of the inspection system 141 that control the lighting device 12 and the image sensor 22.

The information processing device 151 includes a V signal generation unit 161, an image sensor control unit 162, and a lighting control unit 163.

The V signal generation unit 161 generates a vertical synchronization signal (hereafter referred to as a “V signal”) at a predetermined frequency and outputs the generated V signal to the image sensor control unit 162.

The image sensor control unit 162 determines the exposure start timing and the exposure end timing on the basis of the exposure time and the timing of the V signal supplied from the V signal generation unit 161.

The image sensor control unit 162 controls the exposure of the image sensor 22 on the basis of the determined exposure start timing and exposure end timing. The image sensor control unit 162 outputs timing information indicating the exposure start timing and the exposure end timing to the lighting control unit 163. Note that, when the timing information is information indicating the exposure start timing, exposure time information indicating the exposure time is also output.

The lighting control unit 163 determines the turn-on timing of the lighting device 12 in synchronization with the start of exposure and determines the turn-off timing of the lighting device 12 in synchronization with the end of exposure, on the basis of the timing information supplied from the image sensor control unit 162.

The lighting control unit 163 controls the on and off of the lighting device 12 at the determined turn-on timing and turn-off timing.

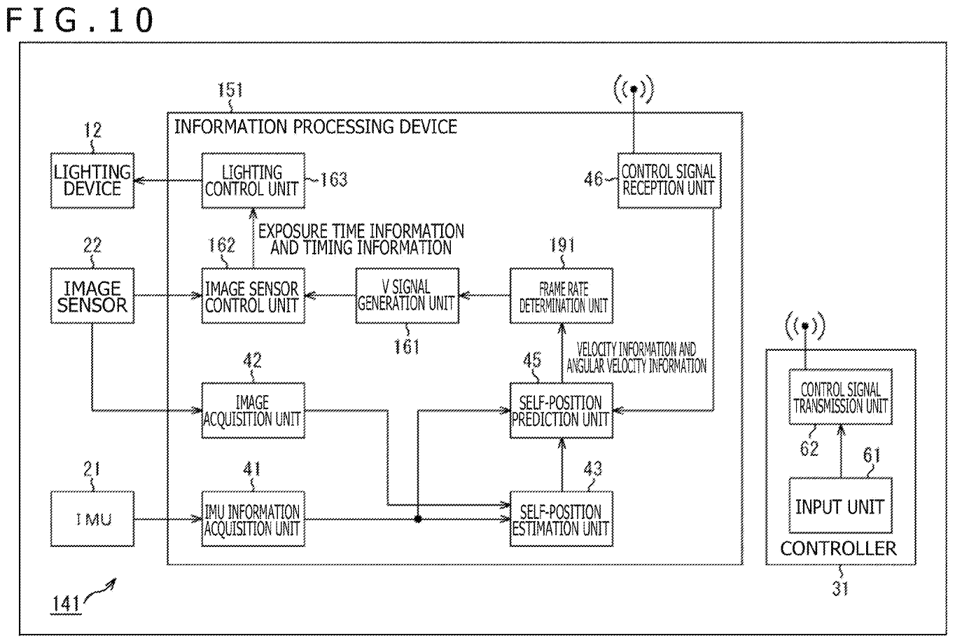

FIG. 10 is a block diagram illustrating a detailed configuration example of the inspection system 141 of FIG. 9.

In FIG. 10, the inspection system 141 includes the information processing device 151, the lighting device 12, the IMU 21, the image sensor 22, and the controller 31. In FIG. 10, parts corresponding to those of FIG. 2 and FIG. 9 are denoted by the same reference signs.

In FIG. 10, the information processing device 151 further includes, in addition to the configuration illustrated in FIG. 9, the image acquisition unit 42, the self-position estimation unit 43, the self-position prediction unit 45, and the control signal reception unit 46 of FIG. 2, and a frame rate determination unit 191.

The frame rate determination unit 191 acquires, of the information indicating the self-position state of the drone 10 predicted by the self-position prediction unit 45, the velocity information and angular velocity information indicating the velocity and angular velocity of the drone 10 from the self-position prediction unit 45. The frame rate determination unit 191 determines the frame rate on the basis of the acquired velocity information and angular velocity information. The frame rate determination unit 191 outputs frame rate information indicating the determined frame rate to the V signal generation unit 161.

The V signal generation unit 161 generates a V signal at a frequency corresponding to the frame rate information supplied from the frame rate determination unit 191.

### <Details of Frame Rate Determination Processing>

The frame rate determination unit 191 acquires the velocity information and angular velocity information supplied from the self-position prediction unit 45. The frame rate determination unit 191 determines the frame rate on the basis of the velocity information and angular velocity information.

For example, the frame rate determination unit 191 determines the frame rate using Equation (2) below.

[Math. 2]

framerate=max(f(v),g(w)) (2)
f( ) and g( ) are functions that take respective values, namely, velocity v and angular velocity w as inputs and return appropriate frame rates for Visual SLAM.

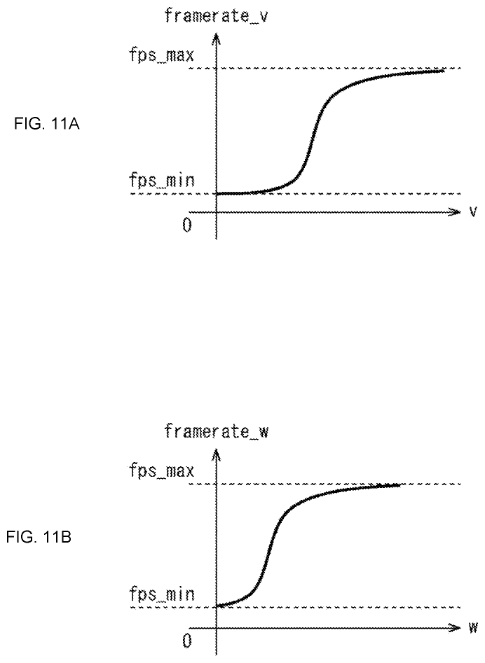

FIG. 11 depicts diagrams illustrating exemplary Lookup Tables representing functions that take the velocity v and the angular velocity w as inputs and return appropriate frame rates for Visual SLAM.

The Lookup Table illustrated in A of FIG. 11 represents f( ) that is a function that takes the velocity v as an input and returns an appropriate frame rate for Visual SLAM. As illustrated in A of FIG. 11, fps_mins≤f( )≤fps_max, and as the velocity v increases, f( )=framerate_v increases.

The Lookup Table illustrated in B of FIG. 11 represents g( ) that is a function that takes the angular velocity w as an input and returns an appropriate frame rate for Visual SLAM. As illustrated in B of FIG. 11, fps_min≤g( )≤fps_max, and as the angular velocity w increases, g( )=framerate_w increases.

Note that the frame rate of the image sensor 22 may be determined on the basis of the distances to the feature points.

For example, the frame rate determination unit 191 determines to lower the frame rate in a case where the position (that is, self-position) of the drone 10 is far from the feature points. By lowering the frame rate, for example, the non-exposure time within one second increases, and it is thus possible to reduce the lighting time of the lighting device 12, thereby reducing power consumption.

As described above, by turning on the lighting device 12 only during the exposure time of the image sensor 22, power consumption can be reduced.

Further, by adaptively lowering the frame rate of the image sensor 22 on the basis of the movement velocity or the distances to the feature points, the flight and operating time of the drone 10 can be extended without compromising the performance of Visual SLAM.

### <Processing of Inspection System>

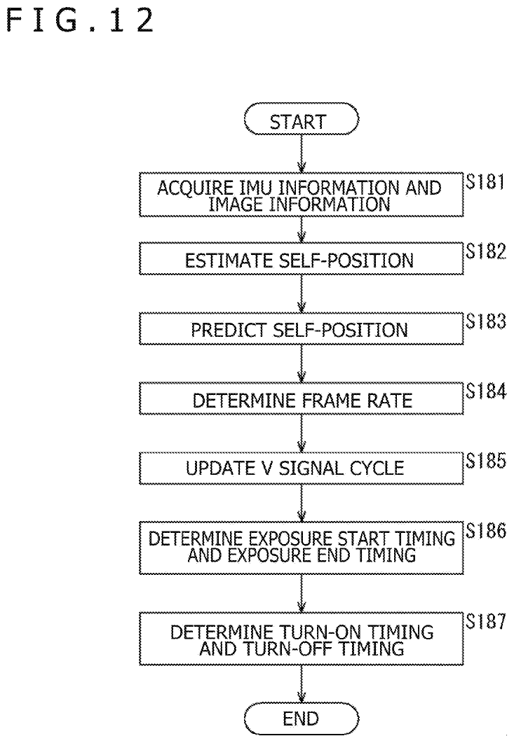

FIG. 12 is a flowchart illustrating the processing of the inspection system 141 of FIG. 10.

In Step S181, the IMU information acquisition unit 41 and the image acquisition unit 42 acquire IMU information and image information, respectively. The IMU information is output to the self-position estimation unit 43 and the self-position prediction unit 45. The image information is output to the self-position estimation unit 43.

In Step S182, the self-position estimation unit 43 performs self-position estimation of the drone 10 on the basis of the IMU information supplied from the IMU information acquisition unit 41 and the image information supplied from the image acquisition unit 42. The result of the self-position estimation is output to the self-position prediction unit 45.

In Step S183, the self-position prediction unit 45 predicts the near-future self-position state on the basis of the result of the self-position estimation supplied from the self-position estimation unit 43 and the IMU information supplied from the IMU information acquisition unit 41. The self-position prediction unit 45 outputs, of the information indicating the predicted self-position state, the velocity information and angular velocity information to the frame rate determination unit 191.

In Step S184, the frame rate determination unit 191 determines the frame rate on the basis of the velocity information and angular velocity information supplied from the self-position prediction unit 45.

In Step S185, the V signal generation unit 161 updates the V signal cycle on the basis of the frame rate information supplied from the frame rate determination unit 191 and generates a V signal at a frequency corresponding to the updated V signal cycle.

In Step S186, the image sensor control unit 162 determines the exposure start timing and the exposure end timing on the basis of the exposure time and the timing of the V signal supplied from the V signal generation unit 161. The image sensor control unit 162 controls the exposure of the image sensor 22 on the basis of the determined exposure start timing and exposure end timing. The image sensor control unit 162 outputs timing information indicating the exposure start timing and the exposure end timing to the lighting control unit 163. Note that, when the timing information is information indicating the exposure start timing, the exposure time information is also output.

In Step S187, the lighting control unit 163 determines the turn-on timing of the lighting device 12 in synchronization with the start of exposure and determines the turn-off timing of the lighting device 12 in synchronization with the end of exposure, on the basis of the timing information supplied from the image sensor control unit 162.

After Step S187, the lighting control unit 163 controls the on and off of the lighting device 12 at the determined turn-on timing and turn-off timing.

As described above, the minimum necessary lighting devices 12 for performing Visual SLAM are turned on, and hence the power consumption of the lighting device 12 is reduced. As a result, the inspection system 141 enables flight without compromising the performance of Visual SLAM and extension of the operating time.

### 3. Third Embodiment (Movement Velocity)

### <Overview of Inspection System>

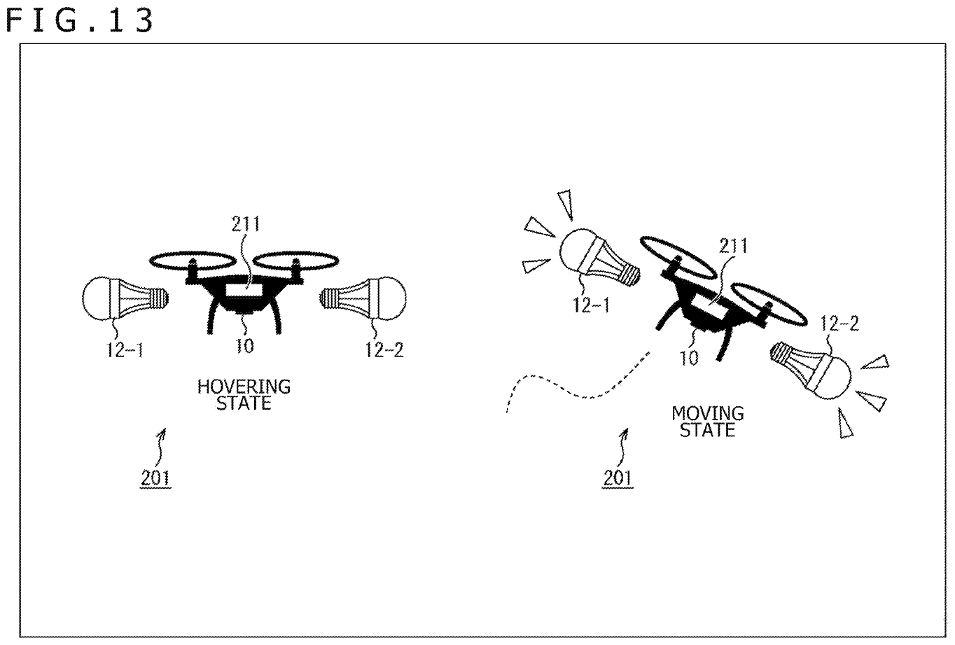

FIG. 13 is a diagram illustrating an overview of an inspection system of a third embodiment to which the present technology is applied.

An inspection system 201 includes the drone 10, an information processing device 211, and the lighting devices 12-1 and 12-2. In FIG. 13, parts corresponding to those of FIG. 1 are denoted by the same reference signs.

The inspection system 201 of FIG. 13 is different from the inspection system 1 of FIG. 1 in that the information processing device 11 is replaced by the information processing device 211.

In the inspection system 201, the information processing device 211 performs Visual SLAM and controls the on and off of the lighting device 12 in response to the movement of the drone 10.

In FIG. 13, in the left part, the inspection system 201 is illustrated with the drone 10 in the hovering state and the lighting device 12 turned off while, in the right part, the inspection system 201 is illustrated with the drone 10 in the moving state and the lighting device 12 turned on.

In Visual SLAM, motion blur in images has a significant impact on accuracy. For example, in low-light environments, in a case where the lighting device 12 is not turned on, the image is too dark to see anything without extending the exposure time, and even when the exposure time is extended, motion blur occurs in the image when the drone 10 moves quickly, thereby making Visual SLAM difficult. On the other hand, in a case where the lighting device 12 is turned on, the exposure time can be shortened, and even when the drone 10 moves quickly, there is no motion blur in the image, but power consumption increases.

However, when the drone 10 is hovering, no motion blur occurs in the image even when the lighting device 12 is not turned on.

From the above, in the inspection system 201, as illustrated in the left part of FIG. 13, the lighting device 12 is turned off in a case where the drone 10 is hovering, and as illustrated in the right part of FIG. 13, the lighting device 12 is turned on in a case where the drone is moving.

From the above, power saving can be achieved without compromising the accuracy of Visual SLAM.

### <First Configuration of Inspection System>

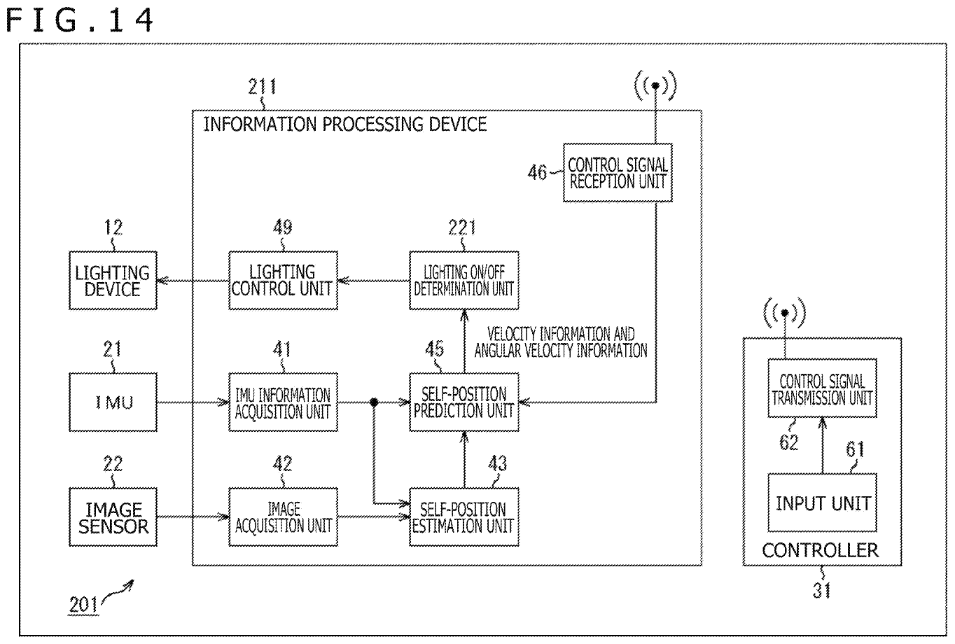

FIG. 14 is a block diagram illustrating a first configuration example of the inspection system 201 of FIG. 13.

In FIG. 14, the inspection system 201 includes an information processing device 211, the lighting device 12, the IMU 21, the image sensor 22, and the controller 31. In FIG. 14, parts corresponding to those of FIG. 2 are denoted by the same reference signs.

In FIG. 14, the information processing device 211 is different from the information processing device 11 of FIG. 2 in that the lighting selection unit 47 is replaced by a lighting On/Off determination unit 221 and that the map information storage unit 44 and the camera parameter information storage unit 48 are removed.

The lighting On/Off determination unit 221 acquires, of the information indicating the self-position state of the drone 10 predicted by the self-position prediction unit 45, the velocity information and angular velocity information indicating the velocity and angular velocity of the drone 10 from the self-position prediction unit 45. The lighting On/Off determination unit 221 determines whether to turn on or off the lighting device 12 on the basis of the acquired velocity information and angular velocity information. The lighting On/Off determination unit 221 outputs the determination result to the lighting control unit 49.

The lighting control unit 49 controls the on and off of the lighting device 12 on the basis of the determination result supplied from the lighting On/Off determination unit 221.

### <Details of Lighting On/Off Determination Processing>

The lighting On/Off determination unit 221 acquires the velocity information and angular velocity information supplied from the self-position prediction unit 45. The lighting On/Off determination unit 221 determines whether to turn on or off the lighting device 12 on the basis of the velocity information and angular velocity information.

For example, the lighting On/Off determination unit 221 calculates a score using Equation (3) below and determines to turn on the lighting device 12 in a case where the calculated score is equal to or greater than a certain threshold Score_th. The lighting On/Off determination unit 221 determines to turn off the lighting device 12 in a case where the calculated score is less than the certain threshold Score_th.

[Math. 3]

Score=max(f(v),g(w)) (3).
f( ) and g( ) are functions that take respective values, namely, the velocity v and the angular velocity w as inputs and convert the inputs into corresponding Scores.

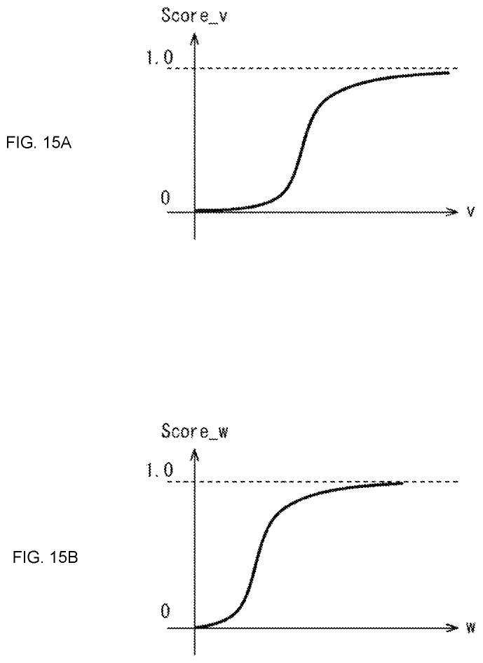

FIG. 15 depicts diagrams illustrating exemplary Lookup Tables representing functions that take the velocity v and the angular velocity w as inputs and convert the inputs into corresponding Scores.

The Lookup Table illustrated in A of FIG. 15 represents f( ) that is a function that takes the velocity v as an input and converts the input into a corresponding Score_v. As illustrated in A of FIG. 15, 0≤f( )≤1.0, and as the velocity v increases, f( )=Score_v increases.

The Lookup Table illustrated in B of FIG. 15 represents g( ) that is a function that takes the angular velocity w as an input and converts the input into a corresponding Score_w. As illustrated in B of FIG. 15, 0≤g( )≤1.0, and as the angular velocity w increases, g( )=Score_w increases.

As described above, by turning on the lighting device 12 only when at least one of the velocity and angular velocity is equal to or greater than the predetermined threshold, it is possible to shorten the exposure time, obtain motion blur-free images for Visual SLAM, and achieve power saving.

### <Processing of Inspection System>

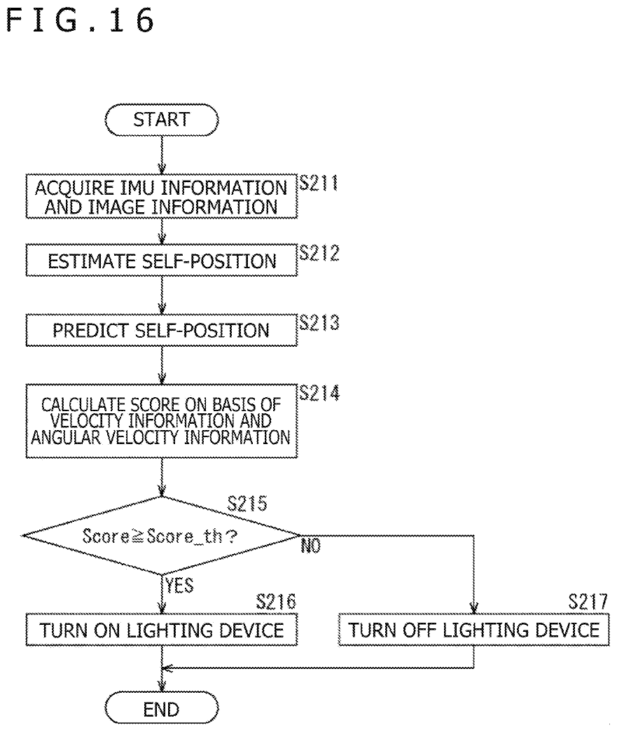

FIG. 16 is a flowchart illustrating the processing of the inspection system 201 of FIG. 14.

In Step S211, the IMU information acquisition unit 41 and the image acquisition unit 42 acquire IMU information and image information, respectively. The IMU information is output to the self-position estimation unit 43 and the self-position prediction unit 45. The image information is output to the self-position estimation unit 43.

In Step S212, the self-position estimation unit 43 performs self-position estimation of the drone 10 on the basis of the IMU information supplied from the IMU information acquisition unit 41 and the image information supplied from the image acquisition unit 42. The result of the self-position estimation is output to the self-position prediction unit 45.

In Step S213, the self-position prediction unit 45 predicts the near-future self-position state on the basis of the result of the self-position estimation supplied from the self-position estimation unit 43 and the IMU information supplied from the IMU information acquisition unit 41. The self-position prediction unit 45 outputs, of the information indicating the predicted self-position state, the velocity information and angular velocity information to the lighting On/Off determination unit 221.

In Step S214, the lighting On/Off determination unit 221 calculates a score on the basis of the velocity information and angular velocity information supplied from the self-position prediction unit 45.

In Step S215, the lighting On/Off determination unit 221 determines whether the calculated score Score is equal to or greater than the predetermined threshold Score_th or not. In a case where it is determined in Step S215 that the calculated score Score is equal to or greater than the predetermined threshold Score_th, the processing proceeds to Step S216. At this time, the lighting On/Off determination unit 221 outputs the determination result (Yes) to the lighting control unit 49.

In Step S216, the lighting control unit 49 turns on the lighting device 12 on the basis of the determination result (Yes) supplied from the lighting On/Off determination unit 221.

In a case where it is determined in Step S215 that the calculated score Score is less than the predetermined threshold Score_th, the processing proceeds to Step S217. At this time, the lighting On/Off determination unit 221 outputs the determination result (No) to the lighting control unit 49.

In Step S217, the lighting control unit 49 turns off the lighting device 12 on the basis of the determination result (No) supplied from the lighting On/Off determination unit 221.

As described above, the minimum necessary lighting devices 12 for performing Visual SLAM are turned on, and hence the inspection system 141 enables flight without sacrificing the performance of Visual SLAM and extension of the operating time.

### <Second Configuration Example of Inspection System>

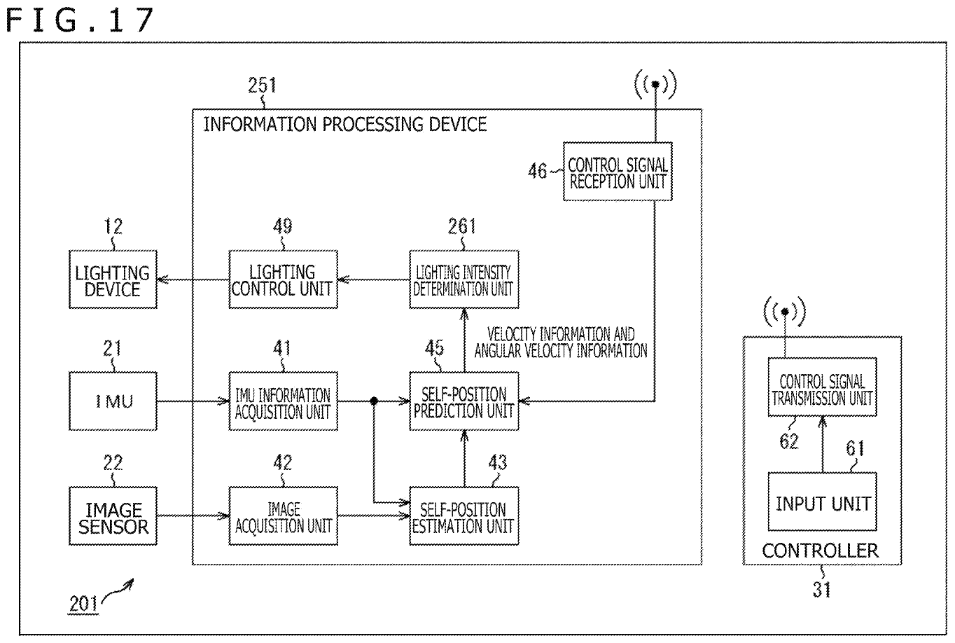

FIG. 17 is a block diagram illustrating a second configuration example of the inspection system 201 of FIG. 13.

The inspection system 201 of FIG. 17 includes an information processing device 251, the lighting device 12, the IMU 21, the image sensor 22, and the controller 31. In FIG. 17, parts corresponding to those of FIG. 14 are denoted by the same reference signs.

In FIG. 17, the information processing device 251 is different from the information processing device 211 of FIG. 14 in that the lighting On/Off determination unit 221 is replaced by a lighting intensity determination unit 261.

That is, the self-position prediction unit 45 outputs, of the information indicating the predicted self-position state, the velocity information indicating the velocity and the angular velocity information indicating the angular velocity to the lighting intensity determination unit 261.

The lighting intensity determination unit 261 determines the lighting intensity of the lighting device 12 on the basis of the velocity information and angular velocity information supplied from the self-position prediction unit 45 and outputs lighting intensity information indicating the determined lighting intensity of the lighting device 12 to the lighting control unit 49.

### <Details of Lighting Intensity Determination Processing>

For example, the lighting intensity determination unit 261 calculates a score using Equation (4) below, and when the calculated score is 1.0, the lighting intensity determination unit 261 increases the intensity of the illuminance 12 to the strongest level. Further, when the calculated score is 0.0, the lighting intensity determination unit 261 reduces the lighting intensity of the lighting device 12 to 0. Note that the processing of reducing the lighting intensity of the lighting device 12 to 0 is similar to the processing of turning off the illuminance 12.

[Math. 4]

Score=(f(v)+g(w))*0.5 (4)

f( ) and g( ) are functions that take respective values, namely, the velocity v and the angular velocity w as inputs and convert the inputs into corresponding Scores.

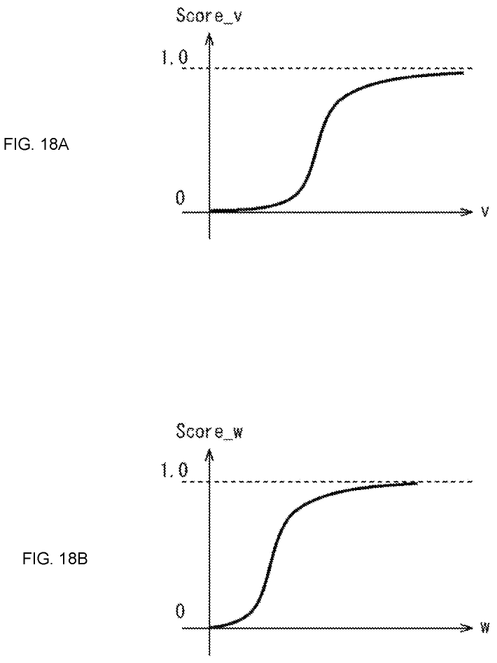

FIG. 18 depicts diagrams illustrating exemplary Lookup Tables representing functions that take the velocity v and the angular velocity w as inputs and convert the inputs into corresponding Scores.

The Lookup Table illustrated in A of FIG. 18 represents f( ) that is a function that takes the velocity v as an input and converts the input into the corresponding Score_v. As illustrated in A of FIG. 18, off( ) ≤1.0, and as the velocity v increases, f( ) Score_v increases.

The Lookup Table illustrated in B of FIG. 18 represents g( ) that is a function that takes the angular velocity w as an input and converts the input into the corresponding Score_w. As illustrated in B of FIG. 18, 0≤g( )≤1.0, and as the angular velocity w increases, g( ) Score_w increases.

As described above, by determining the lighting intensity of the lighting device on the basis of at least one of the velocity and angular velocity, it is possible to shorten the exposure time and obtain motion blur-free images for Visual SLAM.

Note that, as described above, a case where the intensity is 0 is substantially equivalent to a case where the lighting device 12 is off. That is, the lighting intensity of the lighting device, which includes the On/Off of the lighting device, is controlled by the lighting intensity determination unit 261.

Further, since the exposure time also changes depending on the lighting intensity of the lighting device 12, the lighting intensity determination unit 261 determines the exposure time on the basis of the determined lighting intensity of the lighting device 12. For example, by increasing the lighting intensity of the lighting device 12, the exposure time can be shortened. Exposure time information indicating the determined exposure time is output to an image sensor control unit, which is not illustrated. In this case, for example, by exchanging the exposure timing information between the image sensor control unit and the lighting control unit 49, the lighting device 12 may be controlled to be turned on during the exposure time of the image sensor 22 and controlled to be turned off outside the exposure time of the image sensor 22, as in the second embodiment.

The lighting control unit 49 controls the lighting intensity of the lighting device 12 on the basis of the lighting intensity information supplied from the lighting intensity determination unit 261.

As described above, not only the on and off of the lighting device but also the lighting intensity of the lighting device and the exposure time may be changed on the basis of the magnitude of each of the velocity and angular velocity. With this, it is possible to obtain motion blur-free images for

Visual SLAM and achieve power saving.

### <Processing of Inspection System>

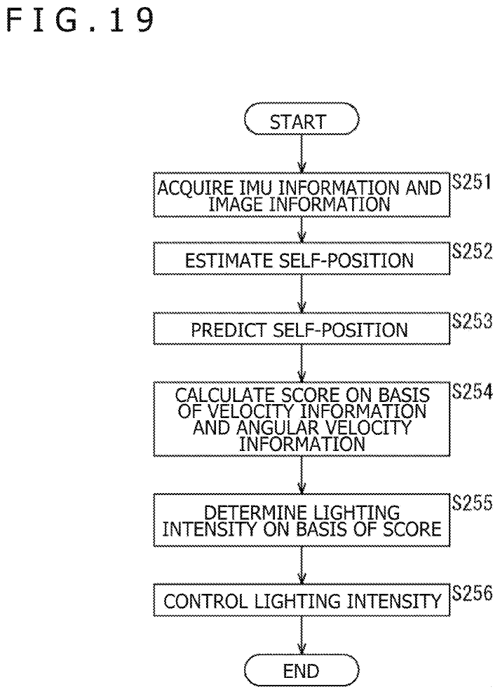

FIG. 19 is a flowchart illustrating the processing of the inspection system 201 of FIG. 17.

In Step S251, the IMU information acquisition unit 41 and the image acquisition unit 42 acquire IMU information and image information, respectively. The IMU information is output to the self-position estimation unit 43 and the self-position prediction unit 45. The image information is output to the self-position estimation unit 43.

In Step S252, the self-position estimation unit 43 performs self-position estimation of the drone 10 on the basis of the IMU information supplied from the IMU information acquisition unit 41 and the image information supplied from the image acquisition unit 42. The result of the self-position estimation is output to the self-position prediction unit 45.

In Step S253, the self-position prediction unit 45 predicts the near-future self-position state on the basis of the result of the self-position estimation supplied from the self-position estimation unit 43 and the IMU information supplied from the IMU information acquisition unit 41. The self-position prediction unit 45 outputs, of the information indicating the predicted self-position state, the velocity information and angular velocity information to the lighting intensity determination unit 261.

In Step S254, the lighting intensity determination unit 261 calculates a score on the basis of the velocity information and angular velocity information supplied from the self-position prediction unit 45.

In Step S255, the lighting intensity determination unit 261 determines the lighting intensity of the lighting device 12 on the basis of the calculated score and outputs the lighting intensity information to the lighting control unit 49.

In Step S216, the lighting control unit 49 controls the lighting intensity of the lighting device 12 on the basis of the lighting intensity information supplied from the lighting intensity determination unit 261. At that time, as described above, the lighting intensity determination unit 261 determines the exposure time on the basis of the determined lighting intensity of the lighting device 12.

As described above, in the inspection system 201, by controlling the on and off of the lighting device 12 on the basis of the magnitude of each of the velocity and angular velocity of the drone 10, power consumption can be reduced.

Further, by adaptively changing the lighting intensity of the lighting device on the basis of the magnitude of each of the velocity and angular velocity, the flight and operating time of the drone 10 can be extended without sacrificing the performance of Visual SLAM.

### 4. Others

### <Effect>

As described above, in the present technology, on the basis of the sensing information acquired by the sensor, which includes the image sensor, and including the image information acquired by the image sensor, self-position estimation of the moving body having mounted thereon the information processing device and generation of map information including three-dimensional information regarding feature points are performed. Then, the lighting device used for imaging by the image sensor is controlled on the basis of at least one of the state of the moving body and the map information.

With this, power saving can be achieved without compromising the accuracy of Visual SLAM.

Note that the technologies described in the first embodiment, the second embodiment, and the third embodiment described above may be combined and implemented.

### <Configuration Example of Computer>

A series of processes described above can be executed by hardware or software. In a case where the series of processes is executed by software, a program configuring the software is installed on a computer incorporated in dedicated hardware or a general-purpose personal computer from a program recording medium.

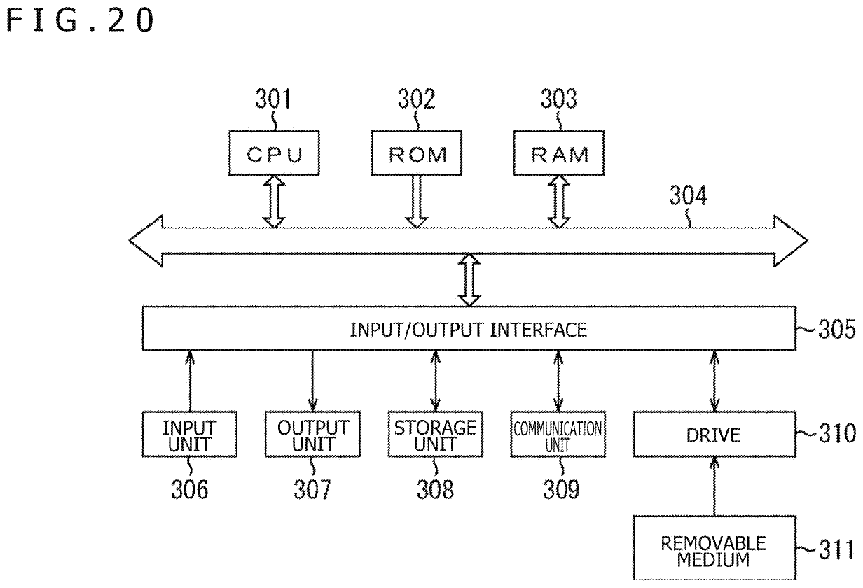

FIG. 20 is a block diagram illustrating a configuration example of the hardware of a computer configured to execute the series of processes described above by the program.

A CPU 301, a ROM (Read Only Memory) 302, and a RAM 303 are connected to each other through a bus 304.

An input/output interface 305 is further connected to the bus 304. The input/output interface 305 is connected to an input unit 306 including a keyboard, a mouse, or the like and an output unit 307 including a display, a speaker, or the like. Further, the input/output interface 305 is connected to a storage unit 308 including a hard disk, a non-volatile memory, or the like, a communication unit 309 including a network interface or the like, and a drive 310 configured to drive a removable medium 311.

In the computer configured as described above, for example, the CPU 301 loads the program stored in the storage unit 308 into the RAM 303 through the input/output interface 305 and the bus 304 and executes the program to perform the series of processes described above.

The program executed by the CPU 301 is recorded on the removable medium 311 to be installed on the storage unit 308, for example. Alternatively, the program is provided via a wired or wireless transmission medium such as a local area network, the Internet, or digital satellite broadcasting to be installed on the storage unit 308.

Note that, as for the program executed by the computer, the processes of the program may be performed chronologically in the order described herein or in parallel. Alternatively, the processes of the program may be performed at appropriate timings such as when the program is called.

Note that “system” herein means a set of a plurality of components (devices, modules (parts), or the like) and that it does not matter whether all the components are in the same housing or not. Thus, a plurality of devices accommodated in separate housings and connected to each other via a network, and a single device including a plurality of modules accommodated in a single housing are both systems.

Further, the effects described herein are only exemplary and not limited, and other effects may be provided.

Embodiments of the present technology are not limited to the embodiments described above, and various modifications can be made without departing from the gist of the present technology.

For example, the present technology can adopt a configuration of cloud computing in which a single function is shared and collaboratively processed by a plurality of devices via a network. Further, the present technology is applicable to data other than audio data.

Further, each step of the flowcharts described above can be executed by a single device or shared and executed by a plurality of devices.

Moreover, in a case where a plurality of processes is included in a single step, the plurality of processes included in the single step can be executed by a single device or shared and executed by a plurality of devices.

### <Combination Example of Configurations>

The present technology can also adopt the following configurations.

(1)

An information processing device including:
a self-position estimation unit configured to perform, on the basis of sensing information acquired by a sensor, which includes an image sensor, and including image information acquired by the image sensor, self-position estimation of a moving body having mounted thereon the information processing device and generation of map information including three-dimensional information regarding a feature point; and
a lighting control unit configured to control a lighting device used for imaging by the image sensor on the basis of at least one of a state of the moving body and the map information.
   (2)

The information processing device according to (1) above, in which the lighting control unit controls the lighting device on the basis of a state of the feature point around the moving body in the map information.

(3)

The information processing device according to (2) above, in which the state of the feature point around the moving body includes at least one of the number of the feature points, a distance to the feature point, and a contrast of the feature point in the map information.

(4)

The information processing device according to (3) above, in which the lighting control unit controls the lighting device on the further basis of ease of tracking the feature point.

(5)

The information processing device according to (3), in which the lighting control unit controls the lighting device on the further basis of a position of an invalid area where the feature point that is valid is not obtained.

(6)

The information processing device according to (5) above, further including:
an invalid area detection unit configured to detect the invalid area using the image information, in which
the lighting control unit controls the lighting device on the basis of a position of the invalid area detected.
   (7)

The information processing device according to (5) above, further including:
a reception unit configured to receive a control signal corresponding to an instruction from a user, in which
the lighting control unit controls the lighting device on the basis of a position of the invalid area indicated by the control signal.
   (8)

The information processing device according to (2) above, in which the lighting control unit controls at least one of an illumination direction of the lighting device and lighting intensity of the lighting device.

(9)

The information processing device according to (1) above, in which the lighting control unit controls the lighting device on the basis of an exposure timing of the image sensor.

(10)

The information processing device according to (9) above, further including:
a frame rate control unit configured to control a frame rate of the image sensor on the basis of at least one of velocity and angular velocity of the moving body, in which
the lighting control unit controls on and off of the lighting device on the basis of the exposure timing of the image sensor determined on the basis of the frame rate.
   (11)

The information processing device according to (10) above, in which the lighting control unit turns on the lighting device during an exposure period of the image sensor and turns off the lighting device outside the exposure period of the image sensor.

(12) The information processing device according to (10) above, in which the frame rate control unit controls the frame rate based on at least one of a distance between the moving body and the feature point, the velocity of the moving body, and the angular velocity of the moving body.
(13)

The information processing device according to (1) above, in which the lighting control unit controls lighting intensity of the lighting device on the basis of at least one of velocity and angular velocity of the moving body.

(14)

The information processing device according to (13) above, in which the lighting control unit controls on and off of the lighting device on the basis of a result of comparing at least one of the velocity and the angular velocity with a predetermined threshold.

(15)

The information processing device according to (13) above, further including:
an image sensor control unit configured to control a length of an exposure period of the image sensor on the basis of the lighting intensity of the lighting device, in which
the lighting control unit turns on the lighting device during the exposure period of the image sensor and turns off the lighting device outside the exposure period of the image sensor.
   (16)

The information processing device according to any one of (1) to (15) above, further including:
a state prediction unit configured to predict the state of the moving body on the basis of a result of the self-position estimation and at least part of the sensing information, in which
the lighting control unit controls the lighting device on the basis of at least one of the state of the moving body predicted and the map information.
   (17)

The information processing device according to any one of (1) to (16) above, in which
the sensor includes at least one of an acceleration sensor and an angular velocity sensor, and
the sensing information includes at least one of velocity and angular velocity of the moving body.
   (18)

The information processing device according to any one of (1) to (17) above, in which the state of the moving body includes at least one of a position, a posture, velocity, and angular velocity of the moving body.

(19)

An information processing method including:
by an information processing device, performing, on the basis of sensing information acquired by a sensor, which includes an image sensor, and including image information acquired by the image sensor, self-position estimation of a moving body having mounted thereon the information processing device and generation of map information including three-dimensional information regarding a feature point; and
controlling a lighting device used for imaging by the image sensor on the basis of at least one of a state of the moving body and the map information.
   (20)

A program for causing a computer to function as:
a self-position estimation unit configured to perform, on the basis of sensing information acquired by a sensor, which includes an image sensor, and including image information acquired by the image sensor, self-position estimation of a moving body having mounted thereon the computer and generation of map information including three-dimensional information regarding a feature point; and
a lighting control unit configured to control a lighting device used for imaging by the image sensor on the basis of at least one of a state of the moving body and the map information.

### REFERENCE SIGNS LIST

1: Inspection system
10: Drone
11: Information processing device
12, 12-1 to 12-n: Lighting device
21: IMU device
22: Image sensor
31: Controller
41: I<U information acquisition unit
42: Image acquisition unit
43: Self-position estimation unit
44: Map information storage unit
45: Self-position prediction unit
46: Control signal reception unit
47: Lighting selection unit
48: Camera parameter information storage unit
49: Lighting control unit
61: Input unit
62: Control signal transmission unit
81: Information processing device
91: Image recognition unit
111: Information processing device
112: Controller
121: Invalid area reception unit
131: Invalid area input unit
132: Invalid area transmission unit
141: Inspection system
151: Information processing device
161: V signal generation unit
162: Image sensor control unit
163: Lighting control unit
191: Frame rate determination unit
201: Inspection system
211: Information processing device
221: Lighting On/Off determination unit
251: Information processing device
261: Lighting intensity determination unit

1. An information processing device comprising:
a self-position estimation unit configured to perform, on a basis of sensing information acquired by a sensor, which includes an image sensor, and including image information acquired by the image sensor, self-position estimation of a moving body having mounted thereon the information processing device and generation of map information including three-dimensional information regarding a feature point; and
a lighting control unit configured to control a lighting device used for imaging by the image sensor on a basis of at least one of a state of the moving body and the map information.

2. The information processing device according to claim 1, wherein the lighting control unit controls the lighting device on a basis of a state of the feature point around the moving body in the map information.

3. The information processing device according to claim 2, wherein the state of the feature point around the moving body includes at least one of the number of the feature points, a distance to the feature point, and a contrast of the feature point in the map information.

4. The information processing device according to claim 3, wherein the lighting control unit controls the lighting device on a further basis of ease of tracking the feature point.

5. The information processing device according to claim 3, wherein the lighting control unit controls the lighting device on a further basis of a position of an invalid area where the feature point that is valid is not obtained.

6. The information processing device according to claim 5, further comprising:
an invalid area detection unit configured to detect the invalid area using the image information, wherein
the lighting control unit controls the lighting device on a basis of a position of the invalid area detected.

7. The information processing device according to claim 5, further comprising:
a reception unit configured to receive a control signal corresponding to an instruction from a user, wherein
the lighting control unit controls the lighting device on a basis of a position of the invalid area indicated by the control signal.

8. The information processing device according to claim 2, wherein the lighting control unit controls at least one of an illumination direction of the lighting device and lighting intensity of the lighting device.

9. The information processing device according to claim 1, wherein the lighting control unit controls the lighting device on a basis of an exposure timing of the image sensor.

10. The information processing device according to claim 9, further comprising:
a frame rate control unit configured to control a frame rate of the image sensor on a basis of at least one of velocity and angular velocity of the moving body, wherein
the lighting control unit controls on and off of the lighting device on the basis of the exposure timing of the image sensor determined on a basis of the frame rate.

11. The information processing device according to claim 10, wherein the lighting control unit turns on the lighting device during an exposure period of the image sensor and turns off the lighting device outside the exposure period of the image sensor.

12. The information processing device according to claim 10, wherein the frame rate control unit controls the frame rate based on at least one of a distance between the moving body and the feature point, the velocity of the moving body, and the angular velocity of the moving body.

13. The information processing device according to claim 1, wherein the lighting control unit controls lighting intensity of the lighting device on a basis of at least one of velocity and angular velocity of the moving body.

14. The information processing device according to claim 13, wherein the lighting control unit controls on and off of the lighting device on a basis of a result of comparing at least one of the velocity and the angular velocity with a predetermined threshold.

15. The information processing device according to claim 13, further comprising:
an image sensor control unit configured to control a length of an exposure period of the image sensor on a basis of the lighting intensity of the lighting device, wherein
the lighting control unit turns on the lighting device during the exposure period of the image sensor and turns off the lighting device outside the exposure period of the image sensor.

16. The information processing device according to claim 1, further comprising:
a state prediction unit configured to predict the state of the moving body on a basis of a result of the self-position estimation and at least part of the sensing information, wherein
the lighting control unit controls the lighting device on a basis of at least one of the state of the moving body predicted and the map information.

17. The information processing device according to claim 1, wherein
the sensor includes at least one of an acceleration sensor and an angular velocity sensor, and
the sensing information includes at least one of velocity and angular velocity of the moving body.

18. The information processing device according to claim 1, wherein the state of the moving body includes at least one of a position, a posture, velocity, and angular velocity of the moving body.

19. An information processing method comprising:
by an information processing device,
performing, on a basis of sensing information acquired by a sensor, which includes an image sensor, and including image information acquired by the image sensor, self-position estimation of a moving body having mounted thereon the information processing device and generation of map information including three-dimensional information regarding a feature point; and
controlling a lighting device used for imaging by the image sensor on a basis of at least one of a state of the moving body and the map information.

20. A program for causing a computer to function as:
a self-position estimation unit configured to perform, on a basis of sensing information acquired by a sensor, which includes an image sensor, and including image information acquired by the image sensor, self-position estimation of a moving body having mounted thereon the computer and generation of map information including three-dimensional information regarding a feature point; and
a lighting control unit configured to control a lighting device used for imaging by the image sensor on a basis of at least one of a state of the moving body and the map information.
